(19) United States
(12) Patent Application Publication
(10) Pub. No.: US 2020/0317023 A1
(43) Pub. Date: Oct. 8, 2020

(54) HEATING, VENTILATION, OR AIR CONDITIONING SYSTEM

(71) Applicant: MAHLE International GmbH, Stuttgart (DE)

(72) Inventor: Oliver SCHULTZE, Stuttgart (DE)

(73) Assignee: MAHLE International GmbH, Stuttgart (DE)

(21) Appl. No.: 16/840,131

(22) Filed: Apr. 3, 2020

(30) Foreign Application Priority Data
Apr. 3, 2019 (DE) 10 2019 204 717.3

(51) Int. Cl. B60H 1/00; F16L 5/08

(52) U.S. Cl. CPC B60H 1/00535; F16L 5/08

(57) ABSTRACT

A heating, ventilation, or air conditioning system having a housing , for a motor vehicle having a firewall, wherein the firewall has at least one opening, wherein the housing projects through the opening, wherein the housing has at least a first housing part and at least a second housing part, wherein the first housing part rests against the firewall with a seal interposed and is attached to the firewall, wherein a portion of the first housing part projects through the opening, and the second housing part is attached in a sealed manner to the portion of the first housing part that projects through the opening.

This nonprovisional application claims priority under 35 U.S.C. § 119(a) to German Patent Application No. 10 2019 204 717.3, which was filed in Germany on Apr. 3, 2019, and which is herein incorporated by reference.

### BACKGROUND OF THE INVENTION

### Field of the Invention

The present invention relates to a heating, ventilation, or air conditioning system for a motor vehicle, and a motor vehicle having a heating, ventilation, or air conditioning system.

### Description of the Background Art

In heating, ventilation, or air conditioning systems for a motor vehicle, it is known that the entire heating, ventilation, or air conditioning system is arranged in the passenger compartment, and only the fresh air supply is routed through an opening in the bulkhead. As a result, the tight space in the engine compartment in front of the bulkhead is not additionally taken up by the arrangement of the heating, ventilation, or air conditioning system. The arrangement of the heating, ventilation, or air conditioning system in the passenger compartment behind the bulkhead, also called the firewall, additionally has the advantage that odors from the engine compartment can be better kept away from the passenger compartment or interior because the fewest possible interfaces of the housing of the heating, ventilation, or air conditioning system, through which odors could enter the heating, ventilation, or air conditioning system, are located in the engine compartment.

In electric vehicles, which is to say in vehicles with an electric drive, space is available in front of the firewall because the drive concept with no internal combustion engine occupies a smaller space and, moreover, the electric motors can also be distributed differently, for example at the wheel hubs or the like. Even in motor vehicles with an internal combustion engine or hybrid drive, space that would be useful can also be available in the engine compartment, depending on the individual case.

### SUMMARY OF THE INVENTION

It is therefore an object of the present invention to provide a heating, ventilation, or air conditioning system for a motor vehicle that additionally uses available space in front of the firewall, and nevertheless achieves appropriate sealing between the available space in front of the firewall and behind the firewall. It is also the object of the present invention to create a motor vehicle with a heating, ventilation, or air conditioning system that additionally uses available space in front of the firewall, and nevertheless achieves appropriate sealing between the available space in front of the firewall and behind the firewall.

In an exemplary embodiment of the invention relates to a heating, ventilation, or air conditioning system having a housing, for a motor vehicle having a firewall, wherein the firewall has at least one opening, wherein the housing projects through the opening, wherein the housing has at least a first housing part and at least a second housing part, wherein the first housing part rests against the firewall with a seal interposed and is attached to the firewall, wherein a portion of the first housing part projects through the opening, and the second housing part is attached in a sealed manner to the portion of the first housing part that projects through the opening. This achieves the result that only one seal is used for sealing relative to the firewall, while further sealing is provided directly between the first housing part and the second housing part, although this sealing must satisfy different requirements.

It is advantageous when the first housing part presses against the firewall while loading the seal, and is attached to the firewall. In this way, the housing of the heating, ventilation, or air conditioning system is attached to the firewall and is at least partially supported, wherein the seal must withstand the loading, in particular should thus have elastic properties, for example.

In addition, it is advantageous when the seal is a compressible seal or an essentially incompressible seal. In this context, a type of the seal material can be chosen depending on the design and pressure.

Thus it is also advantageous, in particular, when the seal is or has a foam seal, in particular of a skinned foam and/or of an impregnated foam, an EPDM, rubber, and/or elastomer seal. In this way, durable sealing can be achieved between the two spatial areas in front of and behind the firewall, and to the interior of the housing.

It is also advantageous when the seal is a seal that surrounds the opening and that rests against the firewall all around the opening. In this way, reliable, full-perimeter sealing with respect to the firewall can be achieved.

It is also advantageous when the first housing part is attached to the firewall by threaded connection, by clips, by means of dovetail connections, and/or by means of suspensions. In this way, rapid and uncomplicated sealing can be achieved.

Furthermore, it is also advantageous when the threaded connection of the first housing part to the firewall is accomplished by means of screws, stud bolts, double-threaded bolts, and/or locked screws through through-holes in the housing part and/or in the firewall.

It is also advantageous when the second housing part is sealed and attached to the first housing part by means of a tongue-and-groove connection. In this way, simple and economical sealing can be achieved.

In an exemplary embodiment of the invention relates to a motor vehicle having a firewall that separates the motor vehicle interior from a motor vehicle front end, and having a heating, ventilation, or air conditioning system according to the invention.

It is advantageous when the first housing part is arranged in the motor vehicle interior and the second housing part is arranged in the motor vehicle front end, or the first housing part is arranged in the motor vehicle front end and the second housing part is arranged in the motor vehicle interior.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic partial representation of a heating, ventilation, or air conditioning system having an attachment to a firewall, and

FIG. 2 is another schematic partial representation of a heating, ventilation, or air conditioning system having an attachment to a firewall.

### DETAILED DESCRIPTION

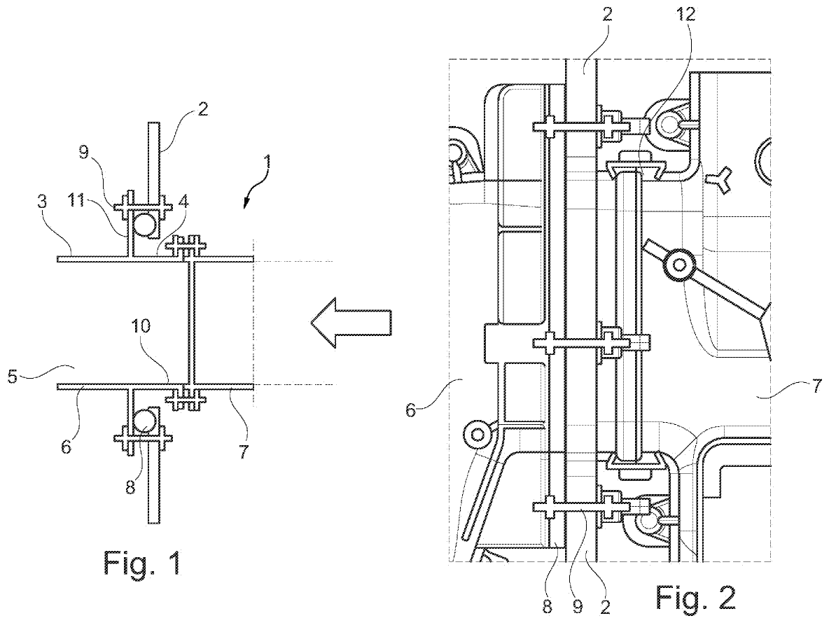

FIG. 1 shows a schematic partial representation of a heating, ventilation, or air conditioning system 1 that is attached to a firewall 2 of a motor vehicle. The firewall 2 in this design separates the vehicle interior from a vehicle front end or an engine compartment.

The heating, ventilation, or air conditioning system 1 has a housing 3 with at least one air duct 5 arranged therein, wherein optional heat exchangers and air flow control elements typically are provided in the housing 3. Depending on the design, an evaporator and/or a heater, an air filter, and a fan may therefore be provided.

The firewall 2 has an opening 4. The housing 3 projects through the opening 4 in order to use space both in front of the firewall 2 and behind the firewall 2 for the heating, ventilation, or air conditioning system 1.

In order to design this in an advantageous way, the housing 3 has at least a first housing part 6 and at least a second housing part 7. The first housing part 6 rests against the firewall 2 with a seal 8 interposed, wherein the first housing part 6 is also attached to the firewall 2 by means of fasteners 9.

The first housing part 6 is preferably arranged largely on one side of the firewall 2, wherein a portion 10 of the first housing part 6 also projects through the opening 4, which is to say on the other side of the firewall 2. The second housing part 7 is attached in a sealed manner to the portion 10 of the first housing part 6 that projects through the opening 4.

It can be seen in FIG. 1 that the first housing part 6 presses against the firewall 2 while loading the seal 8, and is attached to the firewall 2.

The seal 8 can be arranged between the firewall 2 and a flange 11 of the first housing part 6, and is clamped therebetween. Advantageously, the seal 8 is a compressible seal or an essentially incompressible seal that is loaded so as to seal.

In an exemplary embodiment, the seal 8 is a foam seal, in particular of a skinned foam and/or of an impregnated foam, an EPDM, rubber, and/or elastomer seal, or has such a seal. Preferably, the seal 8 is a seal 8 that surrounds the opening 4 and that rests against the firewall 2 all around the opening 4.

It is also advantageous when the first housing part 6 is attached to the firewall 2 by threaded connection, by clips, by means of dovetail connections, and/or by means of suspensions. In this case, the threaded connection of the first housing part 6 to the firewall 2 can be accomplished by means of screws, stud bolts, double-threaded bolts, and/or locked screws through through-holes in the first housing part 6 and/or in the firewall 2.

In addition, it can be seen in FIG. 2 that the second housing part 7 is arranged to be sealed and attached to the first housing part 6 by means of a tongue-and-groove connection 12. For this purpose, a tongue of the first housing part 6 is pushed into a groove of the second housing part 7 and/or a tongue of the second housing part 7 is pushed into a groove of the first housing part 6.

The heating, ventilation, or air conditioning system 1 according to the invention is advantageously installed in a motor vehicle having a firewall 2, wherein the firewall 2 separates the motor vehicle interior from a motor vehicle front end. In this design, the first housing part 6 can be arranged in the motor vehicle interior and the second housing part 7 in the motor vehicle front end, or the first housing part 6 can be arranged in the motor vehicle front end and the second housing part 7 in the motor vehicle interior.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A heating, ventilation, or air conditioning system comprising:
a housing adapted to be arranged in a motor vehicle having a firewall that has at least one opening and the housing projecting through the opening, the housing having at least a first housing part and at least a second housing part, the first housing part resting against the firewall; and
a seal interposed and attached to the firewall,
wherein a portion of the first housing part projects through the opening, and
wherein the second housing part is attached in a sealed manner to the portion of the first housing part that projects through the opening.

2. The heating, ventilation, or air conditioning system according to claim 1, wherein the first housing part presses against the firewall while loading the seal, and is attached to the firewall.

3. The heating, ventilation, or air conditioning system according to claim 1, wherein the seal is a compressible seal or an essentially incompressible seal.

4. The heating, ventilation, or air conditioning system according to claim 1, wherein the seal is or has a foam seal, in particular of a skinned foam and/or of an impregnated foam, an EPDM, rubber, and/or elastomer seal.

5. The heating, ventilation, or air conditioning system according to claim 1, wherein the seal is a seal that surrounds the opening and that rests against the firewall all around the opening.

6. The heating, ventilation, or air conditioning system according to claim 1, wherein the first housing part is attached to the firewall by threaded connection, by clips, by means of dovetail connections, and/or by means of suspensions.

7. The heating, ventilation, or air conditioning system according to claim 1, wherein the threaded connection of the first housing part to the firewall is accomplished by screws, stud bolts, double-threaded bolts, and/or locked screws through through-holes in the housing part and/or in the firewall.

8. The heating, ventilation, or air conditioning system according to claim 1, wherein the second housing part is sealed and attached to the first housing part by a tongue-and-groove connection.

9. A motor vehicle comprising a firewall that separates the motor vehicle interior from a motor vehicle front end, and having a heating, ventilation, or air conditioning system according to claim 1.

10. The motor vehicle according to claim 9, wherein the first housing part is arranged in the motor vehicle interior and the second housing part is arranged in the motor vehicle front end, or wherein the first housing part is arranged in the motor vehicle front end and the second housing part is arranged in the motor vehicle interior.
